(19) United States
(12) Patent Application Publication
(10) Pub. No.: US 2021/0253067 A1
(43) Pub. Date: Aug. 19, 2021

(54) SYSTEM FOR CLEANING AN OPTICAL SENSOR, ASSEMBLY COMPRISING A SYSTEM OF SAID TYPE, AND ASSOCIATED MOTOR VEHICLE

(71) Applicant: Valeo Systèmes d'Essuyage, Le Mesnil Saint Denis (FR)

(72) Inventors: Eric Poton, Issoire (FR); Stéphane Houssat, Issoire (FR); Vincent Gaucher, Le Mesnil Saint Denis (FR)

(73) Assignee: Valeo Systèmes d'Essuyage, Le Mesnil Saint Denis (FR)

(21) Appl. No.: 16/304,944

(22) PCT Filed: May 12, 2017
(86) PCT No.: PCT/EP2017/061441

§ 371 Date: Nov. 27, 2018

(30) Foreign Application Priority Data
May 27, 2016 (FR) 1654757

(51) Int. Cl. B60S 1/56; B08B 3/02; B08B 5/02; B60S 1/52; B60S 1/50; B60S 1/54

(52) U.S. Cl. CPC B60S 1/56; B08B 3/02; B08B 5/02; B08B 2203/0264; B60S 1/50; B60S 1/544; B08B 2203/027; B60S 1/528

(57) ABSTRACT

The invention relates to a system (1) for cleaning an optical sensor (3), in particular for a motor vehicle, comprising: at least one projection member (5) for protecting a cleaning fluid, characterized in that the system (1) includes a confinement wall (11) that supports the at least one projection member (5) and can move from a retracted position in which the confinement wall is designed to be outside the field of view of the optical sensor (3) and a cleaning position in which the confinement wall (11) is designed to be located across from the optical sensor (3) and in which the at least one projection member (5) is positioned in such a way as to project the cleaning fluid against the optical sensor (3).

The present invention relates to the field of optical sensors and in particular optical sensors intended to be mounted on a motor vehicle, and more precisely systems for cleaning such optical sensors.

Rear-view cameras are fitted on many modern motor vehicles, and form part in particular of a parking assistance system that makes it possible to park in a space more easily without having to turn around and detect obstacles behind the vehicle. Cameras are also used on the front of the vehicle or on the sides, replacing or supplementing rear-view mirrors, in order to improve the driver's view.

Backup cameras installed inside the car interior against the rear windshield/glass and that point backward from the rear windshield of the vehicle are known. These cameras are well-protected against external climatic influences and may, for example, have the benefit of systems for defrosting and cleaning the rear windshield, for example a heating wire integrated into the glass of the rear windshield.

However, the viewing angle is not optimal, in particular for parking assistance, and for this reason it is preferred for the camera to be arranged on the rear bumper or on the rear license plate of the vehicle.

In such a case, the camera is therefore highly exposed to projections of dirt that may be deposited on its optics and thus reduce its effectiveness, or even render it inoperative.

In particular, in periods of wet weather or when there is snow in winter, projections of rain, dirt, salts or snow occur that can have a significant adverse effect on the functioning of the viewing system.

There thus appears to be a need to propose an efficient cleaning system for such viewing systems in order to ensure optimal functioning.

The present invention thus aims to propose such a system that allows efficient, rapid cleaning.

To that end, the present invention relates to a system for cleaning an optical sensor, in particular for a motor vehicle, comprising:
at least one element for projection of a cleaning fluid,
   the system also comprising a confinement wall that carries said at least one projection element, said confinement wall being able to move between a retracted position, in which the confinement wall is designed to be positioned outside the field of view of the optical sensor, and a cleaning position, in which the confinement wall is designed to be positioned facing the optical sensor and said at least one projection element is positioned such as to spray cleaning fluid toward the optical sensor.

The at least one projection element may be one of a variety of types familiar to a person skilled in the art: a conventional, fixed ball type, a spray or a retractable squirter mounted on a piston/spring actuated by the pressure of the cleaning fluid.

In one particular embodiment, the system allows, alternately or additionally, drying of an optical sensor.

Additionally and independently, a number of particular aspects of different implementations will now be described.

According to one aspect of the present invention, the confinement wall includes a concave part designed to be oriented toward the optical sensor when the confinement wall is in a cleaning position. Thus, the confinement wall has, for example, a substantially spherical cap form.

According to another aspect of the invention, the cleaning fluid is a liquid and wherein the system comprises:
a reservoir of a cleaning liquid in fluid communication with the projection element,
a pump designed to pump the liquid from the reservoir toward the projection element.

According to an additional aspect of the present invention, the projection element is a squirter designed to spray a cleaning liquid, in particular at an inlet pressure into the squirter of between 1 and 1.7 bar.

According to an additional aspect of the present invention, the confinement wall comprises an internal supply duct connected in a fluid manner to the projection element. In a variant embodiment, the projection element is supplied via a supply duct separate from the wall.

According to another aspect of the present invention, the confinement wall is able to move in rotation.

According to an additional aspect of the present invention, the system comprises an actuator, for example an electric actuator, an electromagnetic actuator or a hydraulic actuator, designed to move the confinement wall between the retracted position and the cleaning position.

According to an additional aspect of the present invention, the actuator is an electric actuator that has an output shaft coupled to the confinement wall.

According to another aspect of the present invention, the actuator comprises a hydraulic ram.

According to an additional aspect of the present invention, the hydraulic ram comprises:
a ram body comprising an input end fitting intended to be in fluid communication with the pump and an output end fitting intended to be in fluid communication with the projection element,
a piston separating the ram body into a first chamber in fluid communication with the input end fitting and a second chamber, said piston being able to move between a proximal position, in which the volume of the first chamber is minimal and in which the output end fitting is in fluid communication with the second chamber, and a distal position, in which the volume of the first chamber is maximal and in which the output end fitting is in fluid communication with the first chamber such as to supply the projection element with cleaning liquid, the movement of the piston from the proximal position to the distal position being generated by the cleaning liquid pumped by the pump.

According to an additional aspect of the present invention, the hydraulic ram comprises an elastic return means arranged in the second chamber and designed to generate the movement of the piston from the distal position to the proximal position when the pump is inactive.

According to another aspect of the present invention, the cleaning fluid is a gas and in particular air. The system comprises an air-compression device, for example, or is to the ventilation/heating system of the vehicle. The air thus generated by the ventilation/heating system may therefore be of hot-air or cold-air type.

The temperature of the drying air may be that of the car interior heating or else be controlled as a function of the outside temperature measured by a temperature sensor.

Two motorized valves, of slide or butterfly type, for example, may allow opening and closing of the line(s) for supplying air outside of the optical sensor cleaning or drying cycle. These valves may be controlled electronically and automatically, in order to be synchronized and timed with an optical sensor washing function, i.e. cleaning with liquid. Control may be simultaneous, or timed to blow after washing of the sensor.

In a variant, air projection is managed separately. This makes it possible, for example, to project air for the entire time when the vehicle is in use, or at the very least in when it is being driven in wet weather, thereby making it possible to disperse water continuously.

In a particular example, the sensor lens receives a hydrophobic treatment. According to another aspect of the present invention, the system also comprises a processing unit designed to control the actuator. The processing unit controls, for example, at least one of the following active elements: the actuator, the air-compression device or the supply-line valves, the pump conveying liquid from the reservoir toward the projection element, or the supplementary pump. The processing unit may thus activate the pump for a first predetermined period of time when a cleaning command is received.

The present invention also relates to an assembly comprising an optical sensor and a system for cleaning the optical sensor as described above.

The present invention also relates to a motor vehicle comprising an assembly as described above.

Further features and advantages of the invention will become apparent from the following description, which is given by way of example and is in no way limiting, with reference to the appended drawings, in which:

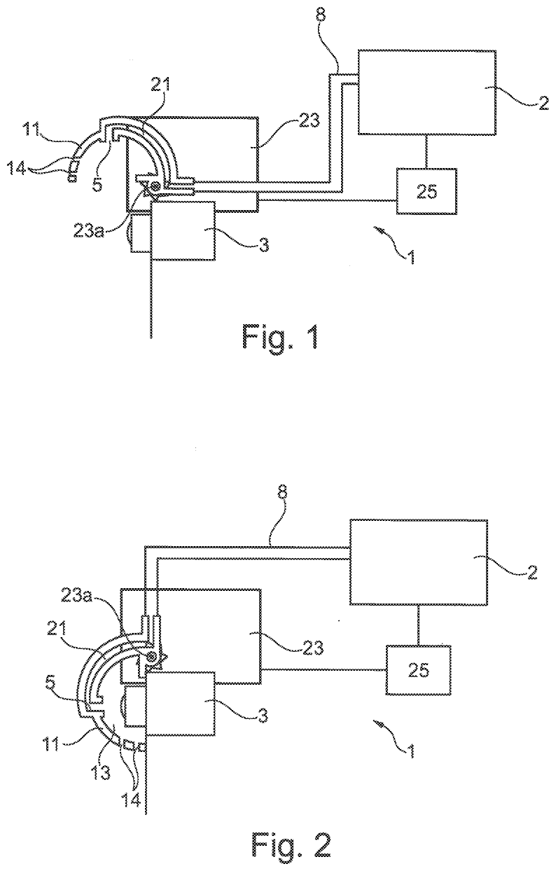

FIG. 1 shows a schematic diagram of a system for cleaning an optical sensor according to a first embodiment and in a retracted position;

FIG. 2 shows a schematic diagram of a system for cleaning an optical sensor according to the first embodiment and in a cleaning position;

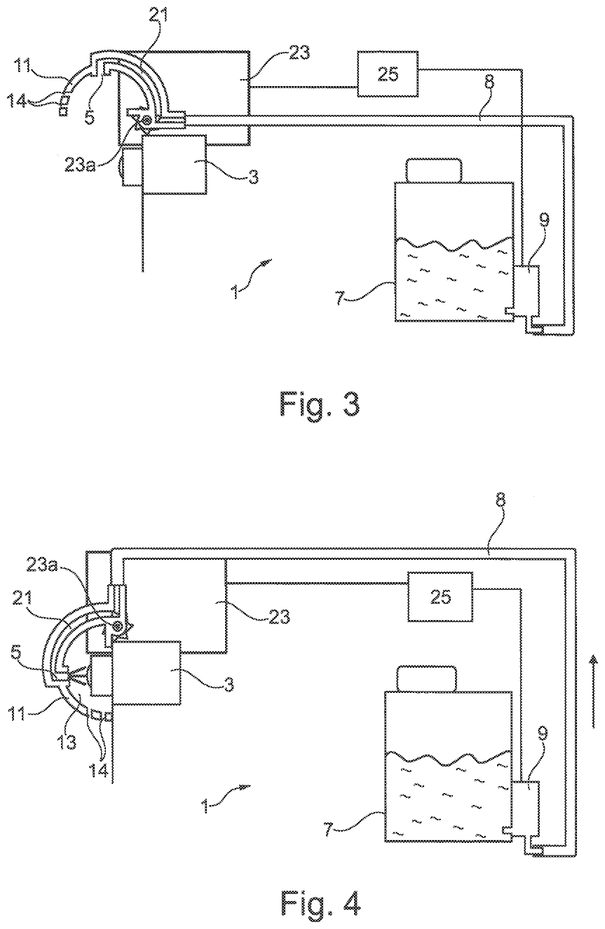

FIG. 3 shows a schematic diagram of a system for cleaning an optical sensor according to a second embodiment and in a retracted position;

FIG. 4 shows a schematic diagram of a system for cleaning an optical sensor according to the second embodiment and in a cleaning position;

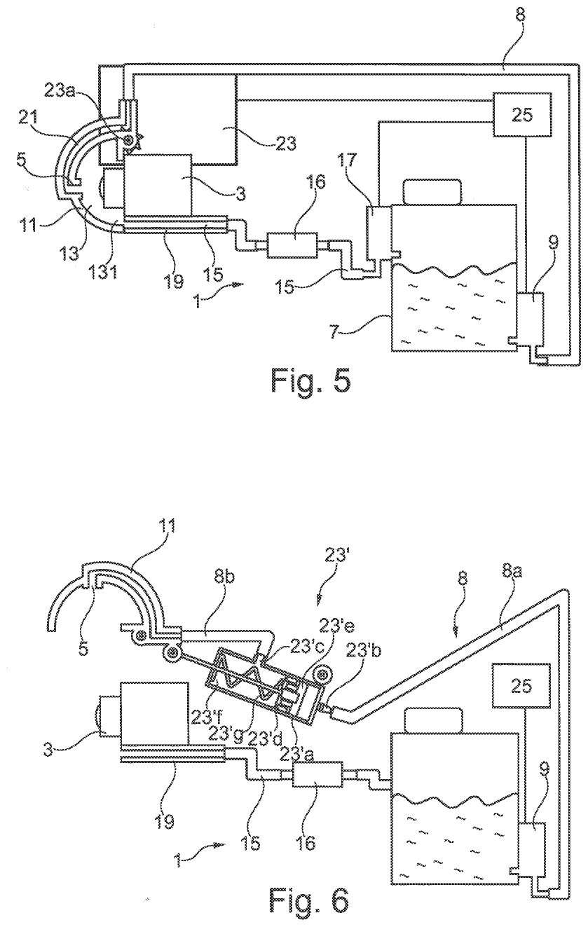

FIG. 5 shows a schematic diagram of a system for cleaning an optical sensor according to a third embodiment and in a cleaning position;

FIG. 6 shows a schematic diagram of a system for cleaning an optical sensor according to a fourth embodiment and in a retracted position;

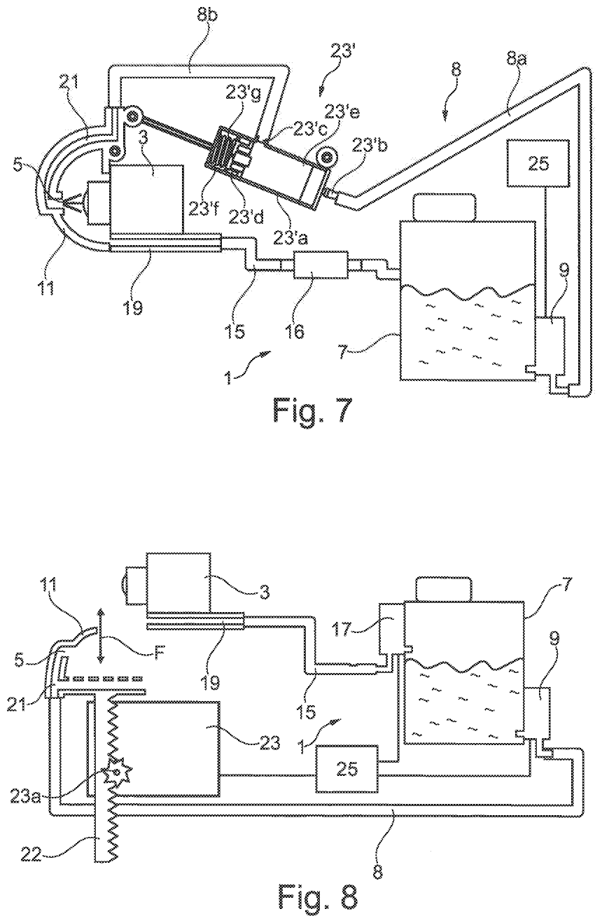

FIG. 7 shows a schematic diagram of a system for cleaning an optical sensor according to the fourth embodiment and in a cleaning position;

FIG. 8 shows a schematic diagram of a system for cleaning an optical sensor according to a fifth embodiment and in a retracted position;

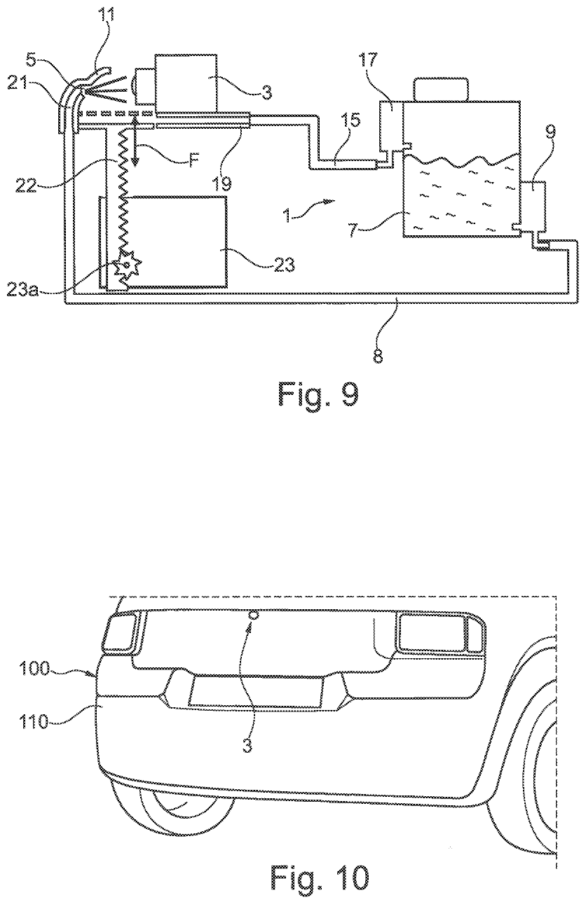

FIG. 9 shows a schematic diagram of a system for cleaning an optical sensor according to a fifth embodiment and in a cleaning position;

FIGS. 10, 11 and 12 show schematic diagrams of a motor vehicle comprising an optical sensor at different locations on the vehicle.

In these figures, elements having identical functions bear the same reference numbers,

In the remainder of the description, the expression “upstream” or “downstream”, when denoting elements of a hydraulic device, denote relative positions of said elements taken in the direction of flow of the fluid, in particular of the liquid.

The following embodiments are examples. Although the description refers to one or more embodiments, this does not necessarily mean that each reference relates to the same embodiment, or that the features apply only to just one embodiment. Single features of different embodiments can also be combined or interchanged in order to create other embodiments.

FIG. 1 shows an example of an optical sensor 3 and a system 1 for cleaning the optical sensor 3. Such a cleaning system 1 is in particular intended for installation on a motor vehicle 100, the optical sensor 3 being, for example, a backup camera on a rear face (rear bumper 110, trunk lid, etc.) of the vehicle 100, as shown in FIG. 10.

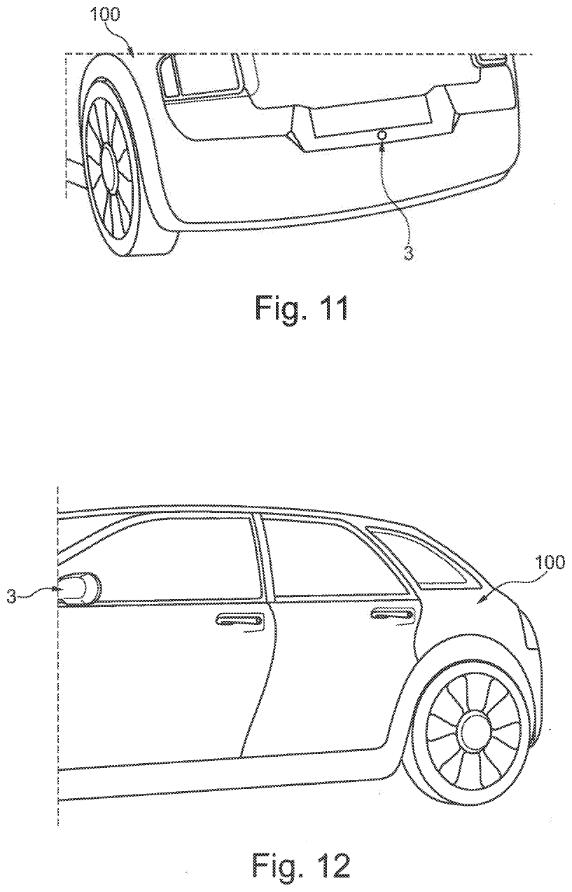

However, other types of optical sensor 3 and other locations on the vehicle may be used, such as, for example, the front face, as shown in FIG. 11, or a side door, as shown in FIG. 12, or, again, a wing, the invention not being limited to the locations described,

The optical sensor 3 includes, for example, a convex (domed) lens, such as one called a fish-eye lens in English.

The system 1 for cleaning the optical sensor 3 comprises an element 5, for projection of a cleaning fluid, designed to project the cleaning fluid onto the lens of the optical sensor 3 at the time when the optical sensor 3 is cleaned. The cleaning fluid may be a liquid, for example a cleaning liquid, or a gas, such as air.

### 1) Cleaning by Means of Gas Projection

In the first embodiment, shown in FIGS. 1 and 2, the cleaning fluid is a gas, for example air. The gas thus projected can, at one and the same time, perform a drying and cleaning function. In the example described, the cleaning system 1 comprises an air-compression device 2, for example an electric compressor, that is connected to the projection element 5, for example via a supply line 8. The supply line 8 includes, for example, one or more rigid or flexible tubes. In a variant, the cleaning system 1 is connected to the ventilation heating system of the vehicle via the supply line 8.

The cleaning system 1 also comprises a confinement wall 11 that is able to move between a retracted position (FIG. 1), in which the confinement wall 11 is positioned outside the field of view of the optical sensor 3, and a cleaning position (FIG. 2), in which the confinement wall 11 is positioned in front of the optical sensor 3 such as to define an enclosure 13 for confinement of the optical sensor 3 in the assembled state of the cleaning system 1. In the example illustrated, the confinement wall 11 in the retracted position has a cap form, protecting the sensor without interfering with the functioning of the sensor. In a variant, the confinement wall 11 in the retracted position is accommodated entirely within a support module. In this first embodiment, the confinement wall 11 is mounted such that it is able to move in rotation in order to allow a pivoting movement. The confinement wall 11 is driven by an actuator 23, for example an electric actuator. The confinement wall 11 is then coupled to the actuator 23 at the output shaft 23a, which allows pivoting thereof between the retracted position and the cleaning position.

The confinement wall 11 includes a concave part oriented toward the optical sensor 3 in the cleaning position. It has, for example, a spherical cap form, of which. However, other forms may also be used.

The projection element 5 is borne by the confinement wall 11. The projection element 5 is, for example, positioned on the confinement wall 11 such as to lie facing the lens of the optical sensor 3 in the cleaning position, as shown in FIG. 2.

The projection element 5 may also be integrated into the confinement wall 11, In the example illustrated, an internal supply duct 21 is, in particular, made in the confinement wall 11, in fluid connection with the projection element 5. The internal supply duct 21 then connects the projection element 5 to the supply line 8.

Alternately, the supply line 8 may be secured to the confinement wall 11 as far as the projection element 5, for example by means of clips or keeper hooks, or any other securing means familiar to a person skilled in the art.

Thus, in order to clean the optical sensor 3, the actuator 23 is commanded to move from the retracted position of FIG. 1 into the cleaning position of FIG. 2. The air-compression device 2 is then activated in order to project air onto the lens of the optical sensor 3, such as to disperse dirt from the lens of the optical sensor 3. The air and the dirt can then be discharged from the confinement enclosure 13 via discharge holes 14 made in the confinement wall 11. A space may also be left between the confinement wall 11 and a wall supporting the optical sensor 3 in order to allow the discharge of the air and dirt. Alternately, the dirt may be discharged when the confinement wall 11 moves from the cleaning position into the retracted position.

When cleaning is complete, the actuator 23 is configured in order to generate the move of the confinement wall 11 from the cleaning position (FIG. 2) into the retracted position (FIG. 1).

### 2) Cleaning by Means of Liquid Spray.

According to a second embodiment, shown in FIGS. 3 and 4, the cleaning fluid is a liquid.

In the case of this embodiment, only the differences as compared to the first embodiment ire FIGS. 1 and 2 will be described.

The projection clement 5 is, for example, embodied as a squirter for spraying a cleaning liquid at a pressure of between 1 and 1.7 bar or as a spray nozzle allowing the cleaning liquid to be sprayed onto the optical sensor 3.

The cleaning system 1 also comprises a reservoir 7, for the cleaning liquid, that is in fluid communication with the projection element 5, for example via a supply line 8.

The cleaning system 1 also comprises at least one pump 9 designed to pump the cleaning liquid from the reservoir 7 and to supply the projection element 5 with cleaning liquid from the reservoir 7. The pump 9 is, for example, an electric pump. The supply line 8 may comprise a non return valve designed to prevent the cleaning liquid from passing through the projection element 5 toward the pump 9 when the pump 9 is inactive. By way of non-limiting example, the pump 9 here is arranged at the reservoir 7, at the interface with the supply line 8, but other arrangements of the pump 9 may also be chosen.

The cleaning system 1 also comprises the wall 11, for confinement of the cleaning liquid, that is able to move between a retracted position (FIG. 3), in which the confinement wall 11 is positioned outside the field of view of the optical sensor 3, and a cleaning position (FIG. 4), in which the confinement wall 11 is positioned in front of the optical sensor 3 such as to define an enclosure 13 for confinement of the cleaning liquid in the assembled state of the cleaning system 1.

The cleaning liquid may be discharged from the confinement enclosure 13 via discharge holes 14 made in the confinement wall 11.

Functioning is, moreover, similar to the first embodiment described in FIGS. 1 and 2.

Alternately or additionally, in the case of these two embodiments, discharge holes 14 may be present in a support 19 of the sensor 3.

3) Cleaning by Means of Liquid, with Recovery of the Liquid

The third embodiment, shown in FIG. 5, is distinguished from those in FIGS. 1 to 4 in particular in that the confinement wall 11 does not comprise discharge holes 14 and forms a confinement enclosure 13, in the cleaning position, that allows the recovery of the cleaning liquid, as shown in FIG. 5. The confinement enclosure 13 thus formed is, in particular, leaktight.

The cleaning system 1 further comprises a discharge conduit 15 for the cleaning liquid that is connected to the confinement enclosure 13 in the cleaning position and designed to make it possible to recover the cleaning liquid after cleaning of the optical sensor 3 and to allow the return of the cleaning liquid toward the reservoir 7.

The discharge conduit 15 is, for example, connected to a low part 131 of the confinement enclosure 13 when the cleaning system 1 is in the assembled state such that the cleaning liquid does not flow under gravity into the recovery enclosure 13 toward the discharge conduit 15.

The discharge conduit 15 is, for example, placed at a height below that of the optical sensor 3 (in the assembled state of the cleaning system 1) and the confinement wall 11 comes into contact with the discharge conduit 15 in the cleaning position.

A seal or a flexible material may be used at the interface between the confinement wall 11 and the discharge conduit 15 to prevent a leak of cleaning liquid.

Furthermore, the discharge conduit 15 may be integrated at least partially into a support 19 of the optical sensor 3. The support 19 is, for example, placed under the optical sensor 3 and comprises an internal duct allowing the cleaning liquid to flow.

Alternately, the discharge conduit 15 may be secured to the support 19 of the optical sensor 3, for example by clips or keeper hooks or any other securing means familiar to a person skilled in the art.

The flow of the cleaning liquid in the discharge conduit 15 of the confinement enclosure 13 as far as the reservoir 7 may be achieved under gravity. In such a case, the reservoir 7 will be positioned at a height below that of the optical sensor 3 and that of the confinement enclosure 13 (in the assembled state of the cleaning system 1). In such a case, the discharge conduit 15 will have an orientation that is inclined toward the reservoir 7.

The flow in the discharge conduit 15 may also be achieved through the action of the pump 9. In such a case, the elements of the cleaning system 1, and in particular the confinement wall 11, will be designed such as to obtain a system, closed in a leaktight manner, in which the cleaning liquid circulates.

Alternately, an additional pump 17 may be arranged at the discharge conduit 15 in order to pump the cleaning liquid from the confinement enclosure 13 as far as the reservoir 7.

As shown in FIG. 5, a filter 16 may also be arranged in the discharge conduit 15 such as to filter out dirt particles, in particular those of a size greater that a predetermined size. In the case of a cleaning system 1 that comprises an additional pump 17, the filter 16 is positioned upstream of the additional pump 17. The filter 16 is, for example, embodied as a charcoal filter or an ultraviolet filter or any other known type of prior-art filter.

In the case of the first three embodiments, the actuator 23 may be an electric actuator, in particular an electric motor designed to move the confinement wall 11 between the retracted position and the cleaning position. In a variant, the actuator is electromagnetic.

### 4) Hydraulic Actuator

According to a fourth embodiment, shown in FIGS. 6 and 7, the actuator 23 may be a hydraulic actuator embodied in the form of a hydraulic ram 23′.

In the case of this embodiment, only the differences as compared to the second and third embodiments will be described.

The hydraulic ram 23′ comprises a ram body 23′a, for example of cylindrical form, comprising an inlet end fitting 23′b connected in a fluid manner to the pump 9 via a first part 8a of the supply line 8 and an outlet end fitting 23′c connected in a fluid manner to the projection element 5 via a second part 8b of the supply line 8.

The inlet end fitting 23′b is, for example, located at a first end of the ram body 23′a. The outlet end flitting 23′c is, for example, located on a lateral edge of the ram body 23′a.

The hydraulic ram 23′ also comprises a piston 23′d separating the ram body 23′a into a first chamber 23′e and a second chamber 23′f.

The first chamber 23′e is in fluid communication with the inlet end fitting 23′b such as to receive the cleaning liquid pumped into the first part 8a of the supply line 8 by the pump 9.

An elastic return means 23′g, for example, a helical spring, is positioned in the second chamber 23′f.

The piston 23′d is able to move between a proximal position and a distal position. In the proximal position, shown in FIG. 6, the volume of the first chamber 23′e is minimal and the outlet end fitting 23′c is in fluid communication with the second chamber 23′f. In the distal position, shown in FIG. 7, the volume of the first chamber 23′e is maximal and the outlet end fitting 23′c is in fluid communication with the first chamber 23′e. Thus, in the distal position, the cleaning liquid is transferred from the first chamber 23′c toward the second part 8b of the supply line 8 such as to supply the projection element 5 with cleaning liquid.

The movement of the piston 23′d from the proximal position to the distal position is generated by the cleaning liquid pumped by the pump 9. Furthermore, the piston 23′d is connected to the confinement wall 11, for example by means of a pivot link, such that the movement of the piston 23′d from the proximal position to the distal position generates the movement of the confinement wall 11 from the retracted position to the cleaning position, Thus, with a hydraulic ram 23′ of this type, actuation of the pump 9 simultaneously allows the confinement wall 11 to move into the cleaning position and the projection element 5 to be supplied with cleaning liquid.

The elastic return means 23′g is designed to generate the movement of the piston 23′d from the distal position to the proximal position when the pump 9 is inactive.

The embodiment shown in FIGS. 6 and 7 also differs from the third embodiment illustrated in FIG. 5 owing to the absence of an additional pump 17. In such a case, the cleaning liquid flows under gravity from the confinement enclosure 13 toward the reservoir 7, as described above.

The hydraulic actuator 23′ of this fourth embodiment can be used in the cleaning systems 1 presented according to the second and third embodiments.

Indeed, a hydraulic actuator of this type may also be used without a recovery conduit 15, for example in the embodiment presented in FIGS. 3 and 4.

Furthermore, instead and in place of the hydraulic actuator 23′, an air actuator based on the same principle as the hydraulic actuator may be used to move the confinement wall 11 between the retracted position and the cleaning position and to allow the projection of air onto the optical sensor 3, as described in the first embodiment.

### 5) Movement of the Confinement Wall 11 in Translation

According to a fifth embodiment, shown in FIGS. 8 and 9, the confinement wall 11 may also be able to move in translation between a retracted position, shown in FIG. 8, and a cleaning position, shown in FIG. 9.

In the case of this embodiment, only the differences as compared to the preceding embodiments will be described.

In this case, a toothed wheel is, for example, mounted on the output shaft 23a of the actuator 23, for example an electric actuator, and a rack 22 is connected to the confinement wall 11 in order to allow the movement thereof in translation, as indicated by the arrow F. Thus, the confinement wall 11 is moved upward in order to move from the retracted position to the cleaning position. In the cleaning position, the projection element 5 lies facing the lens of the optical sensor 3 such that actuation of the pump 9 generates the projection of the cleaning liquid onto the lens of the optical sensor 3. The cleaning liquid then flows under gravity toward the bottom of the confinement wall 11 and then toward the discharge conduit 15. Functioning is, furthermore, similar to the other embodiments described above.

The movement of the confinement wall 11 in translation in this fifth embodiment may be used in the various embodiments presented above. For example, an embodiment without a discharge conduit 15, with a hydraulic actuator and/or an embodiment with projection of air.

The various features of the various embodiments described above may be combined in order to form new embodiments. Furthermore, a cleaning system 1 may at once comprise at least one air projection element 5 and at least one element 5 for projection of cleaning liquid. The two projection elements 5 may then be arranged side-by-side on the confinement wall 11. Cleaning may then comprise a first phase of projection of liquid and a second phase of projection of air so as to allow optimal cleaning and/or drying of the lens of the optical sensor 3.

According to the variant embodiments, the cleaning system 1 may also comprise a processing unit 25 designed to control at least one of the following active elements:
the actuator 23,
the pump 9,
the air-compression device 2,
the valves of the supply line,
the additional pump 17.

The processing unit 25 is connected by means of a communication interface, such as a wired link or wireless communication means, for example via electromagnetic waves such as a WiFi or Bluetooth interface, to one or more active elements to be controlled.

The processing unit 25 is, for example, designed to receive a cleaning command and to actuate the pump 9 and/or the air-compression device 2 for a first predetermined period of time.

In the case of a cleaning system 1 comprising an electric actuator 23, the processing unit 25 also commands the electric actuator 23 in order to position the confinement wall 11 in the cleaning position before or at the same time as actuation of the pump 9. In the case of a cleaning system 1 comprising an additional pump 17, the processing unit 25 also commands actuation of the additional pump 17 for a second predetermined period of time. The second predetermined period of time is, for example, longer than the first predetermined period of time in order to allow discharge of the cleaning liquid at the end of the first predetermined period of time. The second predetermined period of time may also have the same duration as or a shorter duration than the first predetermined period of time, but the start thereof may be offset in time relative to the start of the first period of time in order that the additional pump 17 can continue to be actuated for a predetermined period of time, corresponding to the offset, when the pump 9 is deactivated, such as to allow recovery of the used cleaning liquid.

In the case of a cleaning system 1 comprising a hydraulic actuator 23′, the pump 9 and, as appropriate, the additional pump 17 are controlled by the processing unit 25. The predetermined period of time for which the pump 9 is activated may be longer in this embodiment.

The cleaning command received by the processing unit 25 may be a command initiated by a user, for example via a command element on the dashboard, or may be initiated automatically. The automatic command may be a command at regular intervals of time or a command based on a particular instance of detection or even a combination of the two. For example, cleaning may be initiated at the start or at the end of each use of the optical sensor 3. Cleaning may also be commanded after a predetermined duration of use of the optical sensor 3. This predetermined duration being capable of being modified When certain conditions, for example rainy conditions, are detected. Rain being detected via, for example, a dedicated sensor that may also be used for controling the windshield wipers. An image-processing device may also be associated with the optical sensor 3 in order to detect whether cleaning is necessary.

According to an alternate embodiment, the processing unit 25 may be located outside of the cleaning system 1, for example at a central unit of the motor vehicle.

The present invention also relates to an assembly comprising an optical sensor 3 and a system 1 for cleaning the optical sensor 3 as described above, it being possible for the assembly to comprise the support 19 of the optical sensor 3.

The present invention also relates to a motor vehicle 100 comprising at least one optical sensor 3 and at least one cleaning system 1 associated with the optical sensor 3. Different sites for the optical sensor 3 are shown in FIGS. 10 to 12, in particular at a luggage compartment door, a front bumper or a side opening, but other sites on the vehicle can also be envisaged for the installation of an assembly comprising an optical sensor 3 and an associated cleaning system 1. In the case of a vehicle 100 comprising a plurality of optical sensors 3, these latter may be arranged at different sites on the vehicle, for example at a front bumper, a rear bumper, a wing or a side door. Furthermore, certain elements of the cleaning system 1 may be shared by a plurality of optical sensors 3. A single reservoir 7 may, for example, be used for a plurality of or for all the optical sensors 3 on the vehicle. The processing unit 25 may also be Shared by different optical sensors 3.

The different parts of the supply line 8 and/or of the discharge conduit 15 may be co-extruded, i.e. they may be manufactured as a single line and then cut to the required length in order to reduce the costs of manufacturing the cleaning system 1.

The way in which the cleaning system 1 functions will now be described in the case of two embodiments (with an electric actuator and with a hydraulic actuator),

I) Functioning with an Electric Actuator and without a Discharge Conduit (FIGS. 1 to 4)
a) Cleaning with Air Projection

When a cleaning command is received by the processing unit 25, this latter activates the electric actuator 23 in order to move the confinement wall 11 from the retracted position (FIG. 1) to the cleaning position (FIG. 2), such that the projection element 5 lies facing the optical sensor 3 and a confinement enclosure 13 is formed around the optical sensor 3. Next, the processing unit 25 activates the compressed-air device 2 such that compressed air is conveyed toward the projection element 5 via the supply line 8. Compressed air is then projected onto the optical sensor 3. The first predetermined period of time of activation of the air-compression device 2 lasts, for example, for a few seconds (for example, 5 seconds). The compressed air allows dirt to be dispersed off the lens of the optical sensor 3. The dirt is then discharged outside of the confinement wall 11 under gravity and/or through the effect of the compressed air, for example via discharge holes 14 made in the confinement wall 11. Alternately, the dirt may remain in the confinement enclosure 13 and be discharged when the confinement wall 11 returns to the retracted position.

Once cleaning is complete, i.e. at the end of the first predetermined period of time, the processing unit 25 commands the electric actuator 23 to move the confinement wall 11 from the cleaning position (FIG. 2) to the retracted position. (FIG. 1) such as to free up the field of view of the optical sensor 3 and to allow it to be used.

b) Cleaning with a Liquid Spray

When a cleaning command is received by the processing unit 25, this latter activates the electric actuator 23 in order to move the confinement wall 11 from the retracted position (FIG. 3) to the cleaning position (FIG. 4), such that the projection element 5 lies facing the optical sensor 3 and a confinement enclosure 13 is formed around the optical sensor 3. Next, the processing unit 25 activates the pump 9 such that cleaning liquid is pumped from the reservoir 7 as far as the projection element 5 via the supply line 8. The cleaning liquid is then sprayed onto the optical sensor 3, as shown in FIG. 2. The first predetermined period of time of activation of the pump 9 lasts, for example, for a few seconds (for example, 5 seconds). The cleaning liquid and the dirt then flow over the optical sensor 3 and over the confinement wall 11, in the case of the particles that have been removed from the optical sensor 3 or have run from the projection element 5 toward the bottom of the confinement enclosure 13, and are then discharged outside of the confinement enclosure 1, for example via discharge holes 14.

Once cleaning is complete, i.e. at the end of the first predetermined period of time, the processing unit 25 commands the electric actuator 23 to move the confinement wall 11 from the cleaning position (FIG. 4) to the retracted position (FIG. 3) such as to free up the field of view of the optical sensor 3 and to allow it to be used. The move of the confinement wall 11 into the retracted position may also allow the discharge of dirt and cleaning liquid, which fall through the effect of gravity.

II) Functioning with a Hydraulic Actuator and a Discharge Conduit (FIGS. 6 and 7)

When a cleaning command is received by the processing unit 25, this latter activates the pump 9 such that cleaning liquid is pumped from the reservoir 7 toward the hydraulic ram 23′ via the first part 8a of the supply line 8. The pumped cleaning liquid then generates the movement of the piston 23′d from its proximal position (FIG. 6) toward its distal position (FIG. 7), compressing the elastic return means 23′g. The move of the piston. 23′d into the distal position allows, on the one hand, the move of the confinement wall 11 from the retracted position (FIG. 6) to the cleaning position (FIG. 7) such that the projection element 5 lies facing the optical sensor 3 and a confinement enclosure 13 is formed around the optical sensor 3 and, on the other, the supply of cleaning liquid to the projection element 5 via the second part 8b of the supply line 8. Cleaning liquid is then sprayed onto the optical sensor 3. The first predetermined period of time of activation of the pump 9 lasts, for example, for a few seconds. The cleaning liquid then flows over the optical sensor 3 and over the confinement wall 11, in the case of the particles that have been removed from the optical sensor 3 or have run from the projection element 5 toward the bottom of the confinement enclosure 13. The cleaning liquid is then received by the discharge conduit 15, one end of which is located at the bottom part of the confinement enclosure 13, in order to be redirected toward the reservoir 7. When the cleaning system 1 comprises an additional pump 17, this latter is likewise activated by the processing unit 25 for a second predetermined period of time, for example a few seconds, to allow or to facilitate the return of the cleaning liquid toward the reservoir 7 via the discharge conduit 15. Once cleaning is complete, i.e. at the end of the first predetermined period of time, the processing unit 25 deactivates the pump 3. The elastic return means 23′g then relaxes in order to move the piston 23′d from its distal position toward its proximal position, which generates the movement of the confinement wall 11 from the cleaning position (FIG. 7) to the retracted position (FIG. 6) such as to free up the field of view of the optical sensor 3 and to allow it to be used.

Functioning is similar with a confinement wall 11 moved in translation.

Thus, the cleaning system of the present invention allows efficient cleaning of the lens of the optical sensor 3 by virtue of the ability of the projection element 5, which lies facing the optical sensor 3 upon cleaning, to move.

1. A system for cleaning an optical sensor for a motor vehicle, comprising:
at least one element for projection of a cleaning fluid; and
a confinement wall that carries said at least one projection element, said confinement wall being able to move between a retracted position, in which the confinement wall is positioned outside the field of view of the optical sensor, and a cleaning position, in which the confinement wall is positioned facing the optical sensor, and in which said at least one projection element is positioned such as to spray cleaning fluid toward the optical sensor.

2. The system as claimed in claim 1, wherein the confinement wall has a substantially spherical cap form, and includes a concave part oriented toward the optical sensor when the confinement wall is in a cleaning position.

3. The system as claimed in claim 1, wherein the cleaning fluid is a liquid and wherein the system comprises:
a reservoir of a cleaning liquid in fluid communication with the projection element; and
a pump to pump the liquid from the reservoir toward the projection element.

4. The system as claimed in claim 1, wherein the confinement wall an internal supply duct connected in a fluid manner to the projection element.

5. The system as claimed in claim 1, wherein the confinement wall is able to move in rotation.

6. The system as claimed in claim 3, comprising an actuator to move the confinement wall between the retracted position and the cleaning position.

7. The system as claimed in claim 6, wherein the actuator is an electric actuator that has an output shaft coupled to the confinement wall.

8. The system as claimed in claim 6, wherein the actuator comprises a hydraulic ram.

9. The system as claimed in claim 8, wherein the hydraulic ram comprises:
a ram body comprising an input end fitting in fluid communication with the pump and an output end fitting in fluid communication with the projection element; and
a piston separating the ram body into a first chamber in fluid communication with the input end fitting and a second a chamber, said piston being able to move between a proximal position, in which the volume of the first chamber) is minimal and in which the output end fitting is in fluid communication with the second chamber, and a distal position, in which the volume of the first chamber is maximal and in which the output end fitting is in fluid communication with the first chamber such as to supply the projection element with cleaning liquid, the movement of the piston from the proximal position to the distal position being generated by the cleaning liquid pumped by the pump.

10. The system as claimed in claim 9, wherein the hydraulic ram comprises an elastic return means arranged in the second chamber to generate the movement of the piston from the distal position to the proximal position when the pump is inactive.

11. The system as claimed in claim 1, further comprising a processing unit.

12. The system as claimed in claim 1, wherein the cleaning fluid is air.

13. An assembly comprising: an optical sensor; and a system for cleaning the optical sensor as claimed in claim 1.
